(19) United States
(12) Patent Application Publication
(10) Pub. No.: US 2007/0058060 A1
(43) Pub. Date: Mar. 15, 2007

(54) SOLID STATE IMAGING DEVICE AND ADJUSTMENT METHOD THEREOF

(76) Inventor: Yukio Fujita, Nagasaki (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/531,044

(22) Filed: Sep. 12, 2006

(30) Foreign Application Priority Data
Sep. 13, 2005 (JP) P2005-264988

(51) Int. Cl. H04N 5/335

(52) U.S. Cl. 348/294

(57) ABSTRACT

A solid state imaging device includes: two or more output units, the output unit including a charge/voltage conversion unit adapted to convert signal charges into an electric signal and an output circuit unit adapted to output the electric signal converted by the charge/voltage conversion unit; and a variable capacitor connected to a wiring, the wiring interconnecting the charge/voltage conversion unit and the output circuit unit.

### CROSS REFERENCES TO RELATED APPLICATIONS

The present application claims the benefit of priority to Japanese Patent Application JP 2005-264988 filed in the Japanese Patent Office on Sep. 13, 2005, which is incorporated herein to the extent permitted by law.

### BACKGROUND OF THE INVENTION

1. Field of the Invention

The present invention relates to a solid state imaging device and its adjustment method. More particularly, the present invention relates to a solid state imaging device having two or more charge/voltage conversion units and two or more output circuit units, and to its adjustment method.

2. Description of Related Art

Video cameras and electronic cameras have been using a CCD type solid state imaging device having CCD registers as transfer registers (charge transfer units).

In a CCD type solid state imaging device, a plurality of pixels having photoelectric conversion means (photodiodes: PDs) are disposed in an image area of a semiconductor substrate in an array of two-dimensional layout. Light incident upon each pixel is photoelectrically converted in a photodiode to generate signal charges. The signal charges are transferred to a floating diffusion (FD) unit in an output amplifier unit via a vertical transfer register and a horizontal transfer register. A potential change in the FD unit is detected with a MOS transistor and converted into an electric signal which is amplified and output as an image signal.

FIG. 5 is a schematic diagram illustrating transfer paths of signal charges in registers of a solid state imaging device. In the solid state imaging device shown in FIG. 5, a plurality of pixels are disposed in an image area 101 in a two-dimensional layout and a plurality of registers (not shown) for respective pixel columns are disposed. In an area outside the image area, one horizontal transfer register 102 and one output amplifier unit 103 are disposed.

Signal charges of pixels are read to vertical transfer registers of respective pixel columns at a time, transferred by the vertical transfer registers in a vertical direction (direction indicated by a symbol A in FIG. 5) in response to vertical transfer pulses, and read to the horizontal transfer register one horizontal line after another. Signal charges of one line read to the horizontal transfer register are transferred in the horizontal transfer register in a horizontal direction (direction indicated by a symbol B in FIG. 5) in response to horizontal transfer pulses, and sequentially output to the output amplifier unit. Signal charges are shown by broken line arrows in FIG. 5 (also in FIG. 6).

Multi-pixels are prevailing nowadays for solid state imaging devices of the type described above, and the present state cannot avert a reduction in a frame rate. In order to improve a frame rate even a little, a drive frequency is raised and a transfer time of the vertical register is shortened. However, these countermeasures have a limit because there is a bad effect that a consumption power increases and transfer malfunctions are likely to occur.

As an approach to realizing a high frame rate of a multi pixel solid state imaging device, techniques (for example, refer to Japanese Patent Application Publication No. 2003-309769) have been proposed in which signal charges of one frame are output from a plurality of output amplifier units at the same time. By outputting signal charges from a plurality of output amplifier units at the same time, a high frame rate can be ensured even for multi pixels, without raising a drive frequency and shortening a vertical transfer time.

FIG. 6 is a schematic diagram illustrating transfer paths of signal charges in registers of a solid state imaging device which outputs signal charges of one frame from two output amplifier units at the same time. In the solid state imaging device shown in FIG. 6, a plurality of pixels are disposed in an image area 101 in a two-dimensional layout and a plurality of registers (not shown) for respective pixel columns are disposed. Disposed in an area outside the image area are two horizontal transfer registers (a first horizontal transfer register 102A and a second horizontal transfer register 102B) and two output amplifier units (a first output amplifier unit 103A and a second output amplifier unit 103B). An inter-register transfer gate 104 is provided between the horizontal transfer registers 102A and 102B.

Signal charges of pixels are read to vertical transfer registers of respective pixel columns at a time, transferred by the vertical transfer registers in a vertical direction (direction indicated by a symbol A in FIG. 6) in response to vertical transfer pulses, and sequentially read to the horizontal transfer registers every two horizontal lines. Namely, signal charges of even rows as counted from the bottom of the image area are read to the first horizontal transfer register 102A, and signal charges of odd rows as counted from the bottom of the image area are read to the second horizontal transfer register 102B. Signal charges of two lines read to the horizontal transfer registers are transferred in the horizontal transfer registers in a horizontal direction (direction indicated by a symbol B 1 in FIG. 6 for the first horizontal transfer register, and direction indicated by a symbol B2 in FIG. 6 for the second horizontal transfer register) in response to horizontal transfer pulses, and sequentially output to the output amplifier units.

### SUMMARY OF THE INVENTION

However, as signal charges of one frame are output to a plurality of output amplifier units at the same time, there arises an issue of variance in signal outputs from the output amplifier units. This point will be described in detail in the following.

FIG. 7 is a schematic diagram to be used for explaining a solid state imaging device of related art, particularly its output amplifier unit. The solid state imaging device shown in FIG. 7 has: at the next stage of a horizontal transfer register 102, a discharge device 105 including a floating diffusion FD which is a charge/voltage conversion unit adapted to convert signal charges transferred from the horizontal transfer register via an output gate OG into an electric signal, a reset gate RG and a drain region DD; and at a succeeding stage of the discharge device, an output amplifier unit 103 including an output device 106 and a load resistor 107, the output amplifier unit being an output circuit unit adapted to output the electric signal converted by the floating diffusion.

A change ΔV in voltage from the floating diffusion to be applied to the gate of the output device is dependent upon a total capacitance C_{FD} of the floating diffusion, and is expressed by the following formula (1) where Q is a signal charge amount accumulated in the floating diffusion:
ΔV=Q/CFD (1)

The total capacitance associated with the floating diffusion includes: a junction capacitance CJ between the floating diffusion and an N-type substrate 109; a capacitance CH between the floating diffusion and output gate; a capacitance CR between the floating diffusion and reset gate; a capacitance CD between the drain region and gate electrode of the output device; and a capacitance CS between the source region and gate electrode of the output device, and is expressed by the following formula (2) where a constant g is a gain of a source follower circuit at the first stage of the output amplifier unit:
C_{FD}=C_{R}+C_{H}+C_{J}+C_{D}+(1−g)Cₛ (2)

As seen from the formula (2), the total capacitance associated with the floating diffusion is influenced by many capacitances. Each capacitance influencing the total capacitance has variance to be caused by various factors such as variance in diffusion layers and electrode shapes. When this variance is considered, it is practically impossible to control manufacture processes in such a manner that the total capacitances of floating diffusions at a plurality of output amplifier units are made all equal. As there is variance in total capacitances of floating diffusions at output amplifier units, a voltage change in the floating diffusion to be supplied to the gate of the output device becomes different as seen from the relation of the formula (1), even if the signal charge amount accumulated in each floating diffusion is equal. As described earlier, there is, therefore, variance in signal outputs of the output amplifier units.

If there is variance in signal outputs of the output amplifier units, a displayed whole image has a feeling of visual disorder such as: only an area output from a particular output amplifier unit is viewed dark, and a border between an area output from one output amplifier unit and an area output from another output amplifier unit is clearly viewed.

Accordingly, it is desirable to provide a solid state imaging device and its adjustment method capable of realizing a high frame rate and suppressing sensitivity variance. The present invention is made in view of the above-described issues.

A solid state imaging device of according to an embodiment of the present invention includes: two or more output units, the output unit including a charge/voltage conversion unit adapted to convert signal charges into an electric signal and an output circuit unit adapted to output the electric signal converted by the charge/voltage conversion unit; and a variable capacitor connected to a wiring, the wiring interconnecting the charge/voltage conversion unit and the output circuit unit.

The variable capacitor connected to the wiring interconnecting the charge/voltage conversion unit and the output circuit unit can adjust parasitic capacitance of each charge/voltage conversion unit, whereby the total capacitance associated with the charge/voltage conversion unit can be adjusted. It is therefore possible to reduce variance in conversion efficiencies of the charge/voltage conversion units.

Furthermore, since two or more output units are provided, signals can be output from a plurality of output units at the same time so as that it is possible to retain a high frame rate without raising a drive frequency of the solid state imaging device and shortening a transfer time.

By providing the variable capacitor in each of the output units, parasitic capacitance of any charge/voltage conversion unit can be adjusted in such a manner that a sensitivity of the solid state imaging device is improved.

Namely, since improvement on a sensitivity of the solid state imaging device (an increase in a conversion efficiency of the charge/voltage conversion unit) has become a requisite, it is desired to adjust parasitic capacitance of the charge/voltage conversion unit to improve the sensitivity of the solid state imaging device as much as possible. By providing the variable capacitor in each output unit, it becomes possible to lower a capacitance value of the variable capacitor connected to the output unit having a lower sensitivity. It is possible to reduce the total capacitance value of the charge/voltage conversion unit of the output unit having a lower sensitivity and to improve the conversion efficiency of the charge/voltage conversion unit of the output unit having a lower sensitivity.

If the output unit having a lower sensitivity can be identified beforehand, the variable capacitor may be provided only in this output unit having a lower sensitivity. However, at the manufacture stage of a solid state imaging device, it will be very difficult to identity the output unit having a lower sensitivity. Accordingly, it is practical to say that it is necessary to provide the variable capacitor in each output unit, in order to adjust the charge/voltage control unit and improve the sensitivity of the solid state imaging device, even if any one of the output units has a lower sensitivity.

By using a PN junction capacitor for the variable capacitor, the PN junction capacitor can be formed by semiconductor processing. The N region of the PN junction capacitor (variable capacitor) may be connected to the wiring and the P region may be connected to a voltage application circuit. In this case, by controlling an application voltage value of the voltage application circuit, it is possible to change a depletion layer width of the PN junction capacitor and to adjust the capacitance value of the variable capacitor.

According to another embodiment of the present invention, there is provided an adjustment method for a solid state imaging device including two or more output units, the output unit including an optical reception unit, a charge/voltage conversion unit adapted to convert signal charges photoelectrically converted by the optical reception unit into an electric signal and an output circuit unit adapted to output the electric signal converted by the charge/voltage conversion unit, and a variable capacitor connected to a wiring, the wiring interconnecting the charge/voltage conversion unit and the output circuit unit. The method includes: applying reference light to the optical reception units; detecting electric signals output from the output units; and adjusting a capacitance value of the variable capacitor in accordance with a detection result.

Reference light is applied to the optical reception units, and the capacitance value of the variable capacitor is adjusted in accordance with a detection result of an electric signal output from each output unit. It is therefore possible to adjust the total capacitance associated with the charge/voltage conversion unit by adjusting the parasitic capacitance of the charge/voltage conversion unit, and to reduce variance in conversion efficiencies of the charge/voltage conversion units.

According to the solid state imaging device and its adjustment method according to the embodiments of the present invention, a high frame rate can be realized, and variance in sensitivities of the output units can be suppressed by reducing variance in conversion efficiencies of the charge/voltage conversion units.

### BRIEF DESCRIPTION OF THE DRAWINGS

FIG. 1 is a schematic diagram showing an example of a solid state imaging device according to an embodiment of the present invention.

FIG. 2 is a schematic diagram showing connection destinations of an N region and a P type region of a PN junction capacitor.

FIG. 3 is a schematic diagram illustrating a voltage application circuit.

FIG. 4 is a flow chart illustrating an adjustment method for a solid state imaging device according to an embodiment of the present invention.

FIG. 5 is a schematic diagram illustrating transfer paths of signal charges in registers of a solid state imaging device.

FIG. 6 is a schematic diagram illustrating transfer paths of signal charges in registers of a solid state imaging device which outputs signal charges of one frame from two output amplifier units at the same time.

FIG. 7 is a schematic diagram to be used for explaining a solid state imaging device of related art, particularly its output amplifier unit.

### DETAILED DESCRIPTION OF EMBODIMENTS

With reference to the accompanying drawings, an embodiment of the present invention will be described to help understand the present invention. The embodiment will be described by using as an example a solid state imaging device in which two horizontal transfer registers are provided and signal charges are output form two output amplifier units at the same time.

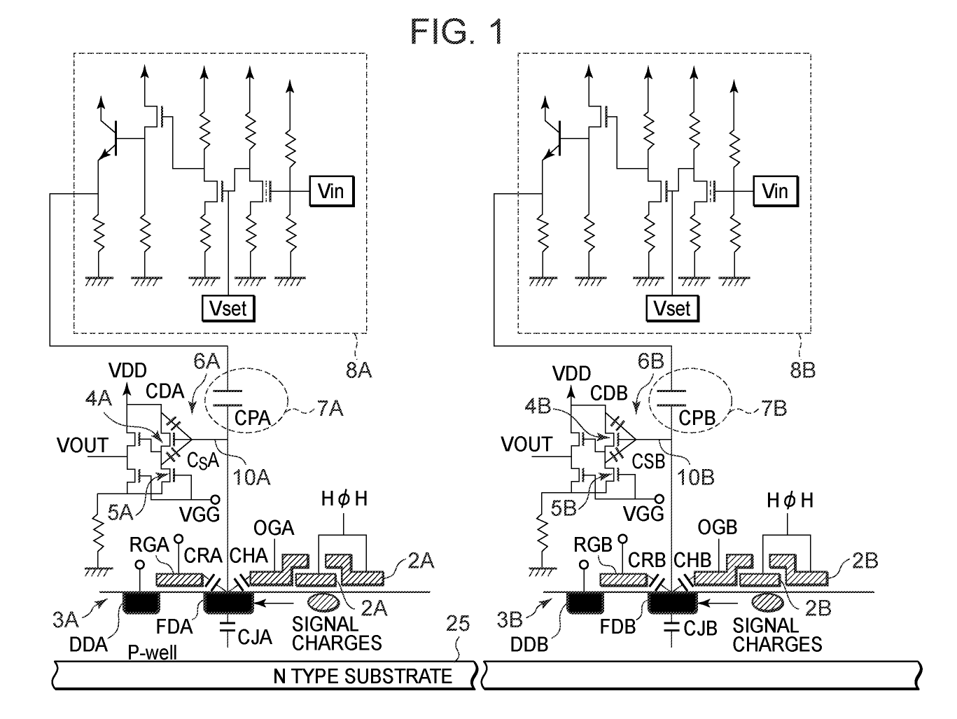

FIG. 1 is a schematic diagram showing an example of a solid state imaging device according to an embodiment of the present invention. The solid state imaging device shown in FIG. 1 has: at the next stages of horizontal transfer registers 2 (a first horizontal transfer register 2A and a second horizontal transfer register 2B) via output gates OG (a first output gate OGA and a second output gate OGB), discharge devices 3 (a first discharge device 3A and a second discharge device 3B) including floating diffusions FDs (a first floating diffusion FDA and a second floating diffusion FDB), reset gates RGs (a first reset gate RGA and a second reset gate RGB) and drain regions DDs (a first drain region DDA and a second drain region DDB); and has, at the succeeding stages of the discharge devices, output amplifier units 6 (a first amplifier unit 6A and a second amplifier unit 6B) including output devices 4 (a first output device 4A and a second output device 4B) and load resistors 5 (a first load resistor 5A and a second load resistor 5B).

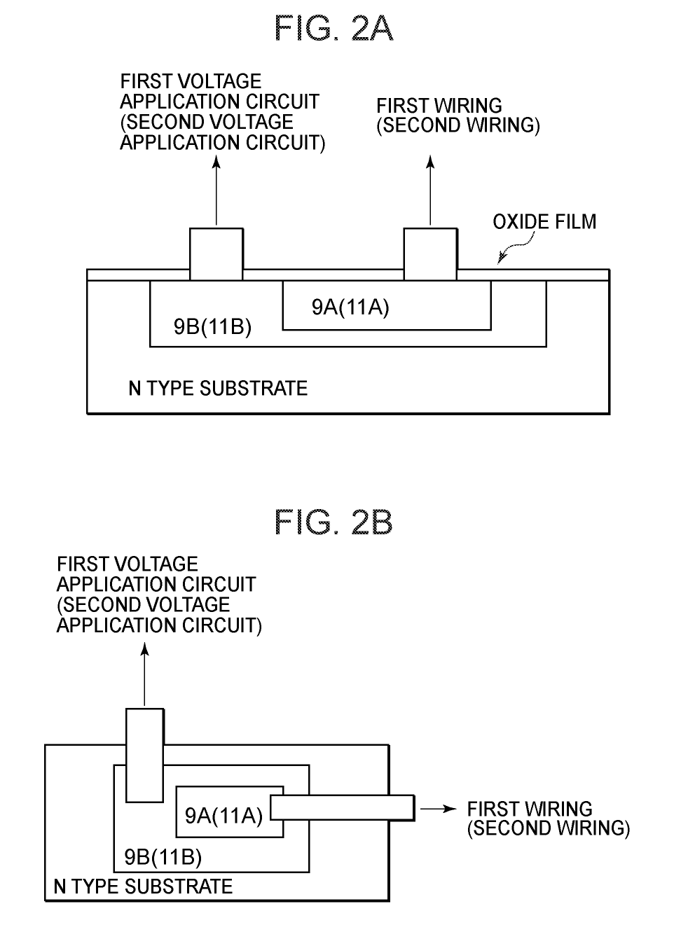

There are also provided a first PN junction capacitor 7A and a second PN junction capacitor 7B as variable capacitors, and a first voltage application circuit 8A for applying voltage to the first PN junction capacitor and a second voltage application circuit 8B for applying voltage to the second PN junction capacitor. An N region 9A of the first PN junction capacitor is connected to a first wiring 10A interconnecting the first floating diffusion and first output amplifier unit, and a P region 9B of the first PN junction capacitor is connected to the first output amplifier unit (refer to FIG. 2). Similarly, an N region 11A of the second PN junction capacitor is connected to a second wiring 10B interconnecting the second floating diffusion and second output amplifier unit, an a P region 11B of the second PN junction capacitor is connected to the second output amplifier unit.

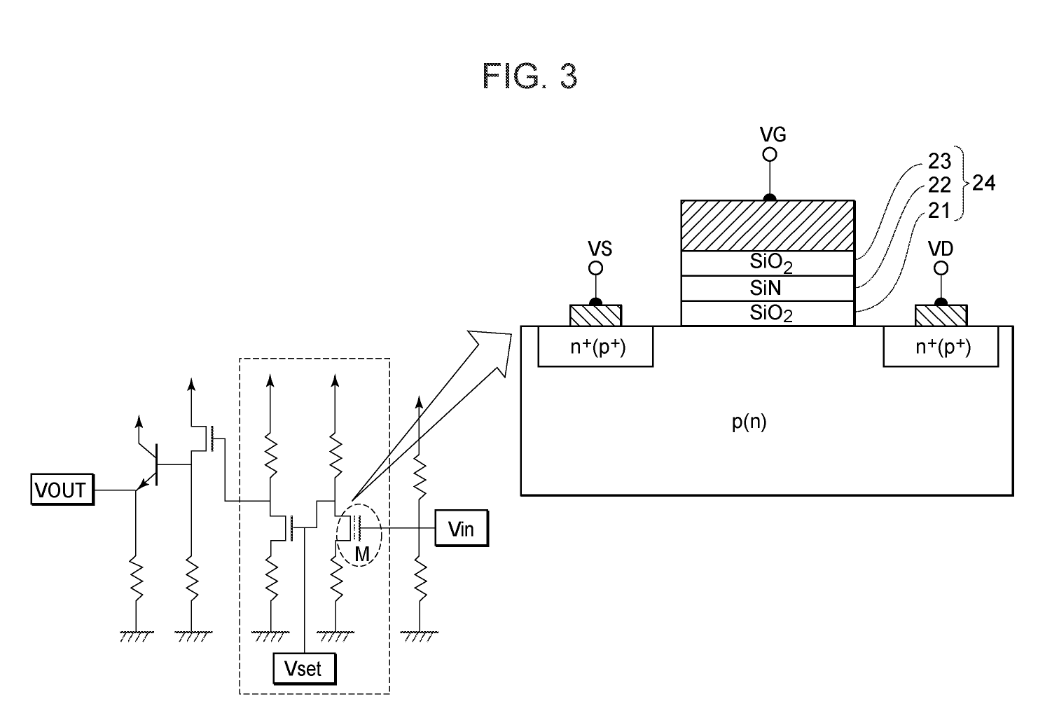

As disclosed for example in Japanese Patent Application Publication No. H08-32065, there is known a method of controlling a threshold value or channel potential of a MIS device having a gate oxide film 24 made of an oxide film (SiO₂) 21, a nitride film (SiN) 22 and an oxide film (SiO₂) 23 layered in this order, by a charge amount injected into the nitride film. In this embodiment, a bias circuit having a MIS device of this type is used as the voltage application circuit (refer to FIG. 3). The voltage application circuit of the embodiment adopts an inverter circuit configuration to obtain a large voltage change by a small amount of potential shift. A high voltage is applied to the gate terminal of a drive MIS transistor M via a terminal Vin to inject charges into the nitride film of the gate insulating film and to adjust a potential under the gate terminal to a desired potential. In this manner, an output voltage can be adjusted in a range from 0 V to a power source voltage.

In the following, description will be made on adjusting a capacitance value of the PN junction capacitor. A length X of a depletion layer of the PN junction capacitor can be expressed by the following formula (3) where N_{D} (atoms/cm³) is a donor impurity concentration, N_{A} (atoms/cm³) is an acceptor impurity concentration, Φ=kT/q×In(N_{D}N_{A}/ni²) and V is a reverse bias voltage (=voltage applied to the N region of the PN junction capacitor−voltage applied to the P region of the PN junction capacitor from the voltage application circuit), and a capacitance value Cp of the PN junction capacitor is expressed by the following formula (4) where A is a junction surface area of the PN junction of the PN junction capacitor:
X=(2εₛᵢε₀(V+Φ)^{1/2}×(1/N_{D}+1/N_{A})^{1/2} (3)
Cₚ=(εₛᵢε₀/X)×A (4)

In adjusting the capacitance value of the PN junction capacitor, first a high voltage is applied to the gate terminal of the drive MIS transistor in the voltage application circuit to inject charges into the nitride film and lower the voltage (voltage applied to the PN junction capacitor) generated by the voltage application circuit from an initial state (e.g., about 12 V) toward 0 V. Since the voltage generated by the voltage application circuit is applied to the P region of the PN junction capacitor, the voltage applied to the P region of the PN junction capacitor lowers as the voltage generated by the voltage application circuit is lowered. The N region of the PN junction capacitor is connected to the wiring interconnecting the floating diffusion and output amplifier unit, and applied with a constant voltage (e.g., about 14 V).

As the voltage applied to the P region of the PN junction capacitor is lowered in the manner described above, the length (width) of the depletion layer expressed by the formula (3) elongates (widens), and a capacitance value of the PN junction capacitor expressed by the formula (4) lowers.

Namely, by applying a high voltage to the gate terminal of the drive MIS transistor in the voltage application circuit, it is possible to lower the capacitance value of the PN junction capacitor.

Table 1 shows the relation between a reverse bias voltage and a capacitance value of the PN junction capacitor, wherein q=1.6×10⁻¹⁹, k=1.38×10⁻²³ [J/deg], nᵢ=1.5×10¹⁰[cm^{-3], N}_{D}=10¹⁶, N_{A}=10¹⁵, T=300 K, and A=16 μm².

TABLE 1

| Reverse Bias voltage (V) | Capacitance (F) |
|---|---|
| 4 | 6.61 × 10⁻¹⁶ |
| 5 | 6.00 × 10⁻¹⁶ |
| 6 | 5.53 × 10⁻¹⁶ |
| 7 | 5.15 × 10⁻¹⁶ |
| 8 | 4.84 × 10⁻¹⁶ |
| 9 | 4.59 × 10⁻¹⁶ |
| 10 | 4.37 × 10⁻¹⁶ |

It can be understood from Table 1 that as the reverse bias voltage is raised, i.e., as a high voltage is applied to the gate terminal of the drive MIS transistor in the voltage application circuit to lower the voltage value to be applied to the P region of the PN junction capacitor from the voltage application circuit, the capacitance value of the PN junction capacitor reduces.

In this embodiment, the first PN junction capacitor is connected to the first floating diffusion and the second PN junction capacitor is connected to the second floating diffusion. However, it is not necessarily required that the PN junction capacitor be connected to both the first and second floating diffusions. The reason for this is in the following. If the PN junction capacitor is connected to one of the floating diffusions, the total capacitance associated with the floating diffusion connected to the PN junction capacitor can be adjusted so as that it is possible to suppress variance in conversion efficiencies of the first and second floating diffusions.

However, if the PN junction capacitor is connected to one of the floating diffusions, the total capacitance associated with this floating diffusion connected to the PN junction capacitance is always adjusted and there may arise the case in which a sensitivity of the solid state imaging device is lowered. More specifically, if the PN junction capacitor is connected only to the first floating diffusion and a conversion efficiency of the second floating diffusion is lower than that of the first floating diffusion, it becomes necessary to lower the conversion efficiency of the first floating diffusion by lowering a voltage value applied to the PN junction capacitor from the voltage application circuit, in order to suppress variance in conversion efficiencies of the first and second floating diffusions. Namely, it is necessary to make the first floating diffusion having a higher conversion efficiency have the lower conversion efficiency of the second floating diffusion, so as that the sensitivity of the solid state imaging device is lowered.

In contrast, if the PN junction capacitor is connected to all floating diffusions, the total capacitance associated with any of the floating diffusions can be adjusted so as that a sensitivity of the solid state imaging device will not be lowered. More specifically, as in this embodiment, the first PN junction capacitor is connected to the first floating diffusion, and the second PN junction capacitor is connected to the second floating diffusion. In this case, if a conversion efficiency of the second floating diffusion is lower than that of the first floating diffusion, a voltage value applied to the second PN junction capacitor from the second voltage application circuit is raised to improve the conversion efficiency of the second floating diffusion. On the other hand, if a conversion efficiency of the first floating diffusion is lower than that of the second floating diffusion, a voltage value applied to the first PN junction capacitor from the first voltage application circuit is raised to improve the conversion efficiency of the first floating diffusion. Namely, it is possible to make the floating diffusion having a lower conversion efficiency have the higher conversion efficiency of the floating diffusion, and a sensitivity of the solid state imaging device will not be lowered.

Therefore, as described above, it is not necessarily required to connect the PN junction capacitor to both the first and second floating diffusions in order to suppress variance in conversion efficiencies of the first and second floating diffusions. However, in order to suppress a sensitivity of the solid state imaging device from being lowered, it is preferable to connect the PN junction capacitor to both the first and second floating diffusions.

The total capacitance C_{FDA} associated with the first floating diffusion includes: a junction capacitance C_{JA} between the first floating diffusion and an N-type substrate 25; a capacitance C_{HA} between the first floating diffusion and first output gate; a capacitance C_{RA} between the first floating diffusion and first reset gate; a capacitance C_{DA} between the drain region and gate electrode of the first output device; a capacitance C_{SA} between the source region and gate electrode of the first output device; and a capacitance C_{PA} of the first PN junction capacitor, and is expressed by the following formula (5):
C_{FDA}=C_{RA}+C_{HA}+C_{JA}+C_{DA}+(1−g)C_{SA}+C_{PA} (5)

Similarly, the total capacitance C_{FDB} associated with the first floating diffusion includes: a junction capacitance C_{JB} between the second floating diffusion and an N-type substrate; a capacitance C_{HB} between the second floating diffusion and second output gate; a capacitance C_{RB} between the second floating diffusion and second reset gate; a capacitance C_{DB} between the drain region and gate electrode of the second output device; a capacitance C_{SB} between the source region and gate electrode of the second output device; and a capacitance C_{PB} of the second PN junction capacitor, and is expressed by the following formula (6):
C_{FDB}=C_{RB}+C_{HB}+C_{JB}+C_{DB+}(1-g)C_{SB+C}_{PB} (6)

As seen from the formula (5), as C_{PA} reduces, the total capacitance C_{FDA} of the first floating diffusion reduces. As seen from the formula (1), as the C_{FDA} reduces, a conversion efficiency of the first floating diffusion is improved.

Namely, as the voltage value applied to the P region of the first PN junction capacitor from the first voltage application circuit is raised, a conversion efficiency of the first floating diffusion can be improved.

Similarly, as seen from the formula (6), as C_{PB} reduces, the total capacitance C_{FDB} of the second floating diffusion reduces. As seen from the formula (1), as the C_{FDB} is reduced, a conversion efficiency of the second floating diffusion is improved.

Namely, as the voltage value applied to the P region of the second PN junction capacitor from the second voltage application circuit is increased a conversion efficiency of the second floating diffusion can be improved.

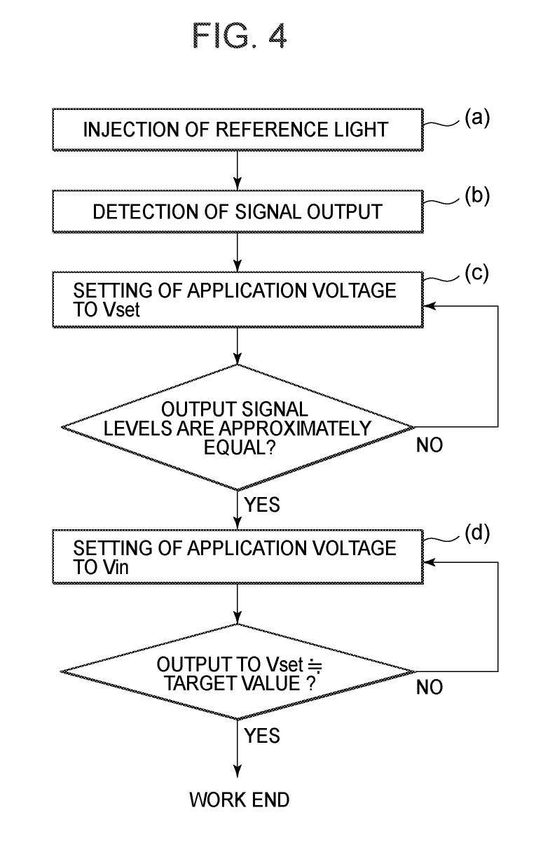

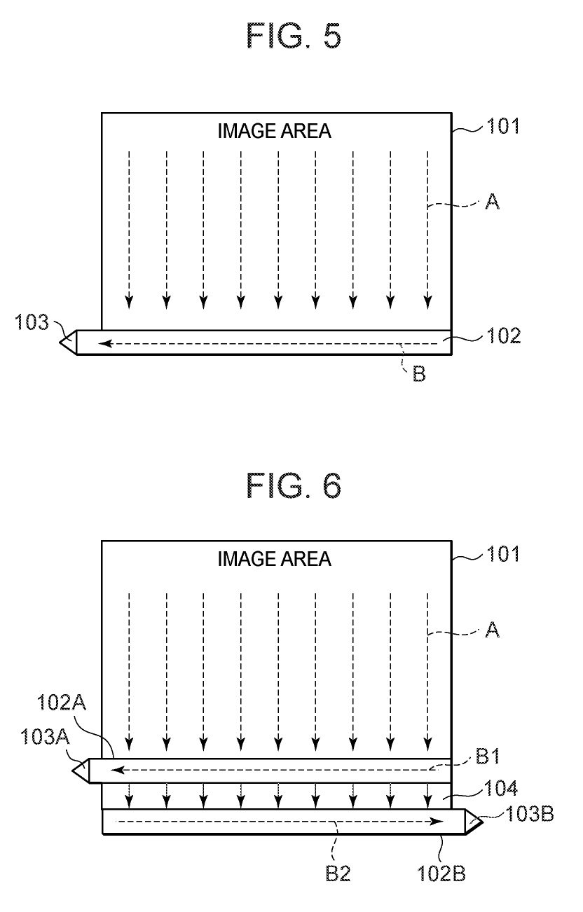

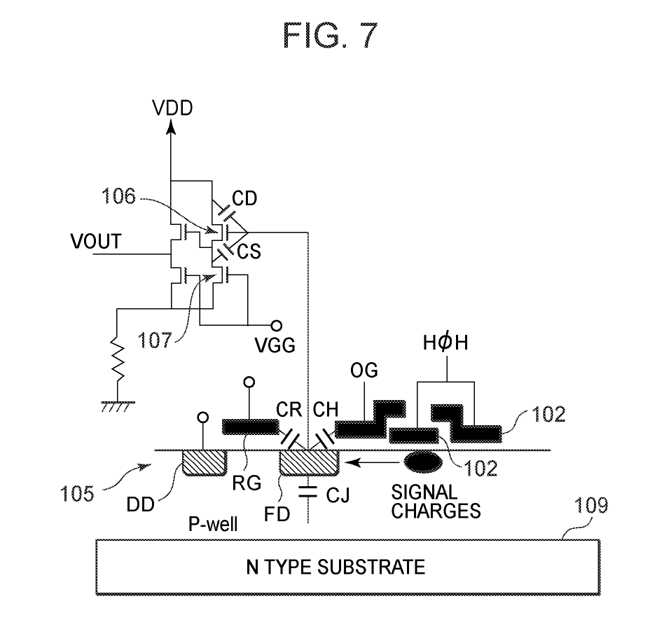

In the following, with reference to FIG. 4, description will be made on a method of adjusting the above-described solid state imaging device. Namely, description will be made on an example of a method of adjusting a solid state imaging device according to an embodiment of the present invention. It is herein assumed that a signal level from the first output amplifier unit is higher than a signal level from the second output amplifier unit, and description will be made by using as an example, adjusting a conversion efficiency of the second floating diffusion to have approximately the same conversion efficiency of the first floating diffusion.

According to an adjustment method for a solid state imaging device according to an embodiment of the present invention, first, light of a uniform and constant light amount (light of a light amount set to the extent that a signal level will not saturate) is made incident upon the image area (refer to (a) in FIG. 4), signal outputs from the first and second output amplifier units are detected (refer to (b) in FIG. 4), and it is detected which of the output signal levels of the first and second output amplifier units is higher, to confirm that the output signal level of the first output amplifier unit is higher than the output signal level of the second output amplifier unit.

Next, in the state that light of a uniform and constant light amount is made incident upon the image area, in order to set a high level to the output signal level of the second output amplifier unit generating an output signal of a low level, i.e., in order to improve the conversion efficiency of the second floating diffusion, a predetermined voltage is applied to the terminal Vset of the second voltage application circuit. It is detected again which of the output signal levels of the first and second output amplifier units is higher. If the output signal level of the first output amplifier unit is higher than that of the second output amplifier unit, an operation of applying a voltage to the terminal Vset is repeated to determine a final voltage value to be applied to the terminal Vset so as that the output signal level of the first output amplifier becomes approximately equal to that of the second output amplifier unit, i.e., the output signal of the second output amplifier becomes approximately equal to that of the first output amplifier unit which is a target output signal level (refer to (c) in FIG. 4). A voltage value applied to the terminal Vset so as to make the output signal level of the first output amplifier unit becomes approximately equal to that of the second output amplifier unit is a target value (voltage) of a potential shift in the second voltage application circuit to be described below.

Next, a pulse voltage is applied to the terminal Vin of the second voltage application circuit to shift a channel potential under the MIS transistor gate, and it is confirmed whether an output voltage at the terminal Vset is equal to the target value described above. If the output voltage at the terminal Vset is equal to the target value, then the adjustment is terminated. If the output voltage at the terminal Vset is not equal to the target value, then a pulse voltage is applied again to the terminal Vin to continue the adjustment until the output voltage at the terminal Vset becomes equal to the target value (refer to (d) in FIG. 4). A potential shift amount is controlled by a voltage applied to the MIS transistor gate from the Vin terminal and a voltage application time.

With the flow described above, it is possible to adjust the output signal level of the first output amplifier unit to as to become approximately equal to that of the second output amplifier unit.

According to the solid state imaging device and its adjustment method according to an embodiment of the present invention, a capacitance value of the PN junction capacitor can be adjusted by making the voltage application circuit control a voltage to be applied to the P region of the PN junction capacitor. By adjusting the capacitance value of the PN junction capacitor, the total capacitance associated with the floating junction can be adjusted so as that variance in conversion efficiencies of the floating diffusions can be suppressed and sensitivity variance can be reduced.

In this embodiment, although the description has been made by using as an example a solid state imaging device which outputs signals from the two output amplifier units at the same time, it is not necessarily required to use two output amplifier units outputting signals at the same time, but a solid state imaging device which outputs signals from three or more output amplifier units may also be used.

The present application contains subject matter related to Japanese Patent Application JP 2005-264988 filed in the Japanese Patent Office on Sep. 13, 2005, the entire content of which being incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A solid state imaging device comprising:
two or more output units, the output unit including a charge/voltage conversion unit adapted to convert signal charges into an electric signal and an output circuit unit adapted to output the electric signal converted by the charge/voltage conversion unit; and
a variable capacitor connected to a wiring, the wiring interconnecting the charge/voltage conversion unit and the output circuit unit.

2. The solid state imaging device according to claim 1, wherein:
the variable capacitor is provided in each of the output units.

3. The solid state imaging device according to claim 1, wherein:
the variable capacitor is a PN junction capacitor;
an N region of the PN capacitor is connected to the wiring; and
a P region is connected to a voltage application circuit.

4. An adjustment method for a solid state imaging device, wherein:
the solid state imaging device includes
two or more output units, the output unit including an optical reception unit,
a charge/voltage conversion unit adapted to convert signal charges photoelectrically converted by the optical reception unit into an electric signal and an output circuit unit adapted to output the electric signal converted by the charge/voltage conversion unit, and
a variable capacitor connected to a wiring, the wiring interconnecting the charge/voltage conversion unit and the output circuit unit;
the adjustment method including
applying reference light to the optical reception units,
detecting electric signals output from the output units, and
adjusting a capacitance value of the variable capacitor in accordance with a detection result.

5. The adjustment method for a solid state imaging device according to claim 4, wherein:
the capacitance value of the variable capacitor is adjusted so as to increase the electric signal output from the output unit.

6. A solid state imaging device comprising:
two or more output means, each of the output means including a charge/voltage conversion means for converting signal charges into an electric signal and an output circuit means for outputting the electric signal converted by the charge/voltage conversion means; and
a variable capacitor means connected to a wiring, the wiring interconnecting the charge/voltage conversion means and the output circuit means.
